(19) United States
(12) Patent Application Publication
(10) Pub. No.: US 2008/0284764 A1
(43) Pub. Date: Nov. 20, 2008

(54) Electronic paper apparatus and its driving circuit and manufacturing method

(75) Inventor: Wen-Jyh Sah, Tainan City (TW)

Correspondence Address: BIRCH STEWART KOLASCH & BIRCH, PO BOX 747, FALLS CHURCH, VA, 22040-0747, US

(73) Assignee: Gigno Technoogy Co., Ltd.

(21) Appl. No.: 12/153,108

(22) Filed: May 14, 2008

(30) Foreign Application Priority Data
May 18, 2007 (TW) 096117786

(51) Int. Cl. G09G 5/00; G09G 3/36

(52) U.S. Cl. 345/205; 345/92

(57) ABSTRACT

A driving circuit of electronic paper apparatus for driving at least one pixel having a pixel switch element includes a shift unit and a sample-hold unit. The sample-hold unit has a sample-hold switch element and a sample-hold energy-storage element. The shift unit outputs a switch control signal. The sample-hold switch element is electrically connected to the pixel switch element and the shift unit, and turns on or off in accordance with the switch control signal. The sample-hold energy-storage element is electrically connected to the sample-hold switch element and the pixel switch element. An electronic paper apparatus and a manufacturing method thereof are also disclosed.

### CROSS REFERENCE TO RELATED APPLICATIONS

This Non-provisional application claims priority under 35 U.S.C. §119(a) on Patent Application No(s). 096117786 filed in Taiwan, Republic of China on May 18, 2007, the entire contents of which are hereby incorporated by reference.

### BACKGROUND OF THE INVENTION

1. Field of Invention

The invention relates to an electronic paper apparatus and its driving circuit and manufacturing method.

2. Related Art

An active matrix type display apparatus is driven by a column driver and a row driver, which are cooperated with timing control so as to display an image frame.

As shown in FIG. 1, a conventional display apparatus includes a display panel 11 and a column driver 12 which is connected to the display panel 11 by a plurality of data lines D₀₁ to D₀ₘ electrically.

The column driver 12 is consisted of a shift register unit 122, a first stage latch unit 123, a second stage latch unit 124, and a level shift unit 125. The shift register unit 122 is electrically connected to the first stage latch unit 123. The second stage latch unit 124 is electrically connected to the first stage latch unit 123 and the level shift unit 125.

Each data line needs one corresponding first stage latch unit 123, second stage latch unit 124 and level shift unit 125, so that the cost grows up when the size of the display apparatus becomes larger, which is uneconomic benefit.

### SUMMARY OF THE INVENTION

In view of the foregoing, the invention is to provide an electronic paper apparatus and its driving circuit and manufacturing method with simple driving configuration for performing the column driving.

To achieve the above, the invention discloses a driving circuit of an electronic paper apparatus for driving at least one pixel having a pixel switch element. The driving circuit includes a shift unit and a sample-hold unit. The sample-hold unit has a sample-hold switch element and a sample-hold energy-storage element. The shift unit outputs a switch control signal. The sample-hold switch element is electrically connected to the pixel switch element and the shift unit, and turns on or off in accordance with the switch control signal. The sample-hold energy-storage element is electrically connected to the sample-hold switch element and the pixel switch element.

In addition, the invention also discloses an electronic paper including a substrate, a driving circuit and a pixel array. The substrate has a surface. The driving circuit has a shift unit and a sample-hold unit and is disposed on the surface of the substrate. The sample-hold unit has a sample-hold switch element and a sample-hold energy-storage element. The sample-hold switch element is electrically connected to the shift unit and the sample-hold energy-storage element, respectively. The pixel array has a pixel switch element and a pixel equivalent capacitance, and is disposed on the surface of the substrate. The pixel switch element is electrically connected to the sample-hold switch element, the sample-hold energy-storage element and the pixel equivalent capacitance respectively.

To achieve the above, the invention further discloses a manufacturing method of an electronic paper apparatus. The manufacturing method includes the steps of disposing a shift unit on a surface of a substrate, disposing a sample-hold switch element on the surface of the substrate, disposing a sample-hold energy-storage element on the surface of the substrate, and disposing a pixel array on the surface of the substrate.

As mentioned above, the E-paper apparatus and its driving circuit of the invention utilize the shift unit, the sample-hold switch element and the sample-hold energy-storage element to form the driving circuit for driving the pixel array of the E-paper to display the image. Comparing to the prior art, the driving circuit of the invention is simpler and the manufacturing process thereof can be integrated with that of the pixel array so as to reduce the manufacturing cost.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic diagram showing a column driver of a conventional display apparatus;

FIG. 2 is a schematic diagram showing an electronic paper (E-paper) apparatus according to a preferred embodiment of the invention;

FIG. 3 is an equivalent circuit diagram of a driving circuit and a pixel array of the E-paper apparatus according to the preferred embodiment of the invention;

FIG. 4 is a timing chart showing the sample-hold unit and the pixel array of FIG. 3; and

FIG. 5 is a flow chart of a manufacturing method of an E-paper according to the preferred embodiment of the invention.

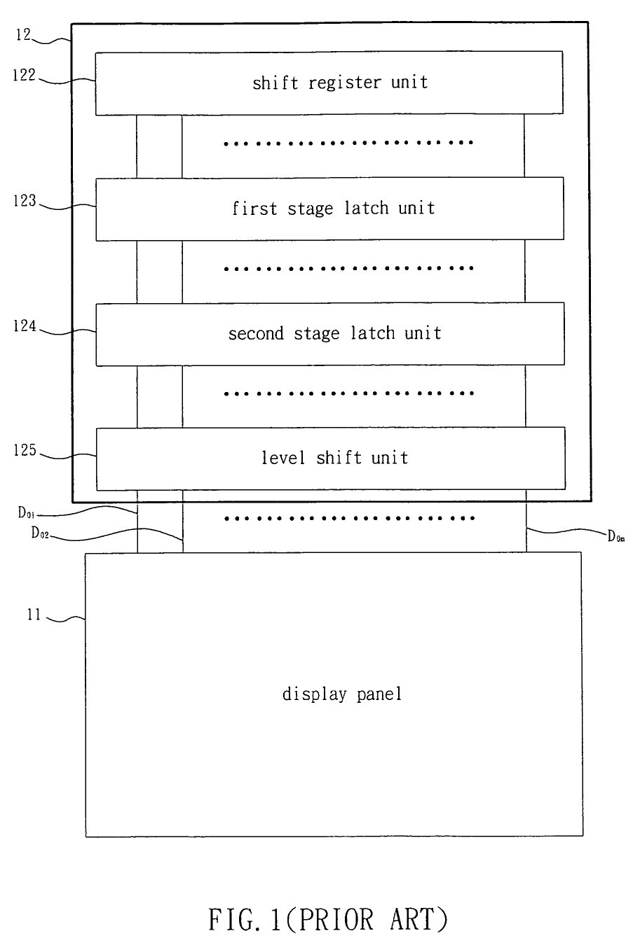

### DETAILED DESCRIPTION OF THE INVENTION

The present invention will be apparent from the following detailed description, which proceeds with reference to the accompanying drawings, wherein the same references relate to the same elements.

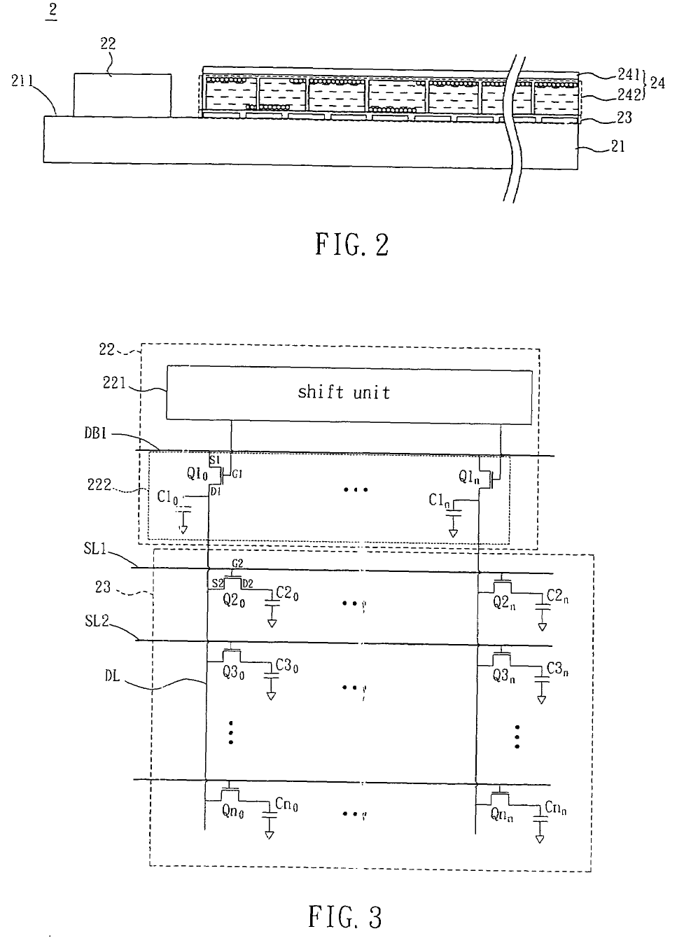

As shown in FIG. 2, an E-paper apparatus 2 according to a preferred embodiment of the invention includes a substrate 21, a driving circuit 22, a pixel array 23 and an E-paper 24. The driving circuit 22 and the pixel array 23 is disposed on a surface 211 of the substrate 21 and adjacent to each other. The E-paper 24 is disposed opposite to the pixel array 23 and includes an opposite electrode unit 241 and an electrophoretic material unit 242. The opposite electrode unit 241 is disposed opposite to the pixel array 23. The electrophoretic material unit 242 is disposed between the opposite electrode unit 241 and the pixel array 23. Due to the opposite electrode unit 241 must be transparent, the material of the opposite electrode unit 241 may be indium tin oxide (ITO), aluminum zinc oxide (AZO), indium zinc oxide (IZO) or cadmium tin oxide (CTO). In addition, in the embodiment, the substrate 21 may be a transparent substrate such as, for example but not limited to, a glass substrate, and the pixel array 23 may be an active matrix type pixel array.

As shown in FIG. 3, the driving circuit 22 has a shift unit 221 and a sample-hold unit 222. In the embodiment, the sample-hold unit 222 includes a plurality of sample-hold switch element Q1₀ to Q1ₙ and a plurality of sample-hold energy-storage element C1₀ to C1ₙ. Taking one set of the sample-hold switch element Q1₀ and the sample-hold energy-storage element C1₀ as an example, the sample-hold switch element Q1₀ is electrically connected to the shift unit 221 and the sample-hold energy-storage element C1₀, respectively.

The pixel array 23 has a plurality of pixels, which includes a plurality of pixel switch elements Q2₀ to Qnₙ and a plurality of pixel equivalent capacitances C2₀ to Cnₙ. For example, the pixel switch element Q2₀ is electrically connected to the sample-hold switch element Q1₀, the sample-hold energy-storage element C1₀ and the pixel equivalent capacitance C2₀. In the embodiment, one set of the sample-hold switch element Q1₀ and the sample-hold energy-storage element C1₀ is electrically connected to the corresponding pixels through a data line DL.

To be noted, each of the pixel equivalent capacitances may include a pixel capacitance, a storage capacitance or a stray capacitance existing in the structure (not shown). In the embodiment, it is described in equivalent circuit concept.

As shown in FIG. 3, the shift unit 221 of the driving circuit 22 can be a shift register. In the embodiment, each sample-hold energy-storage element includes a capacitance, and each sample-hold switch element includes a thin-film transistor (TFT). For example, the sample-hold switch element Q1₀ has a gate G1, a drain D1 and a source S1. The gate G1 is electrically connected to the shift unit 221. The source S1 receives a pixel data via a data bus DB1. The drain D1 is electrically connected to the sample-hold energy-storage element C1₀ and the pixel switch element Q2₀.

To be noted, in the embodiment, the driving circuit 22 and the pixel array 23 are presented by equivalent circuits. However, the real structure can be designed according to the actual requirement and not limited to that shown in the figure. For example, each sample-hold switch element can be consisted of a plurality of TFTs, and the connecting relation may be different from the above. In addition, each sample-hold energy-storage element can be presented by the real capacitor. Alternatively, the sample-hold energy-storage element can be formed between the data line and the scan line. That is, the capacitance of the sample-hold energy-storage element can be formed by two conductive layers.

In addition, each pixel switch element of the pixel array 23 includes a TFT. For example, the pixel switch element Q2₀ has a gate G2, a drain D2 and a source S2. The gate G2 is electrically connected to a scan line SL1, the source S2 is electrically connected to sample-hold energy-storage element C1₀ of the driving circuit 22 and the drain D1 of the sample-hold switch element Q1₀, and the drain D2 is electrically connected to the pixel equivalent capacitance C2₀. In addition, the pixel equivalent capacitance C2₀ may be equivalent to at least one capacitor.

The following descriptions will take a single set of the sample-hold switch element and the sample-hold energy-storage element as an example. In the E-paper apparatus 2, the shift unit 221 generates a switch control signal to turn on or turn off the sample-hold switch element Q1₀. When the sample-hold switch element Q1₀ turns on, the pixel data is transmitted to the sample-hold energy-storage element C1₀ through the data bus DB1. In one image frame time, a scan signal is transmitted to the corresponding pixel through the scan line SL1 to turn on the pixel switch element Q2₀. At this time, the pixel data stored in the sample-hold energy-storage element C1₀ is transmitted to the pixel equivalent capacitance C2₀ through the pixel switch element Q2₀, so that the pixel can display the image corresponding to the pixel data.

To be noted, the driving circuit 22 of the embodiment is, for example, a column driving circuit, which can be disposed in a chip or formed on the substrate 21 as an integrated circuit by the semiconductor process. Alternatively, at least one of the shift unit 221, the sample-hold switch elements Q1₀ to Q1ₙ and the sample-hold energy-storage elements C1₀ to C1ₙ of the driving circuit 22 can be disposed in the chip or on the substrate 21. In the embodiment, the E-paper apparatus 2 further includes a row driving circuit (not shown) for driving the scan line SL1.

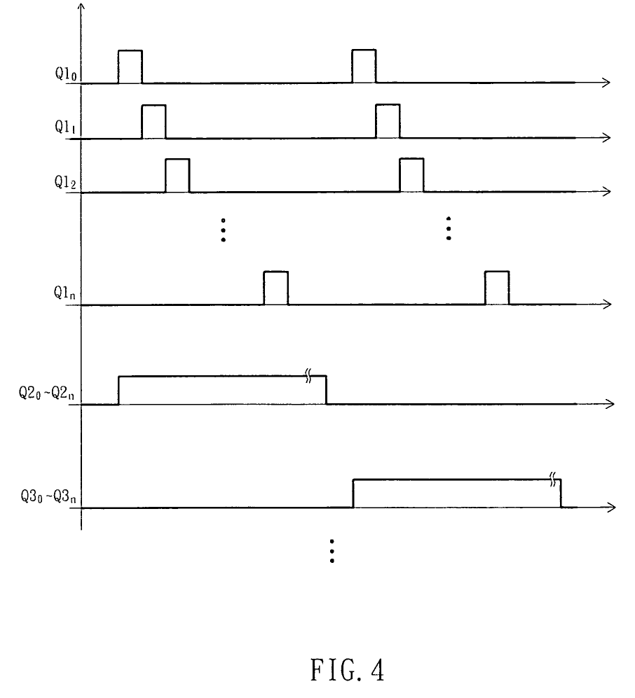

FIG. 4 is a timing chart of the sample-hold unit 222 and the pixel array. As shown in FIG. 4, when the image data are written into the pixel electrically connected to the scan line SL1, the sample-hold switch elements Q1₀ to Q1ₙ are turned on in series so as to transmit the needed image data to the sample-hold energy-storage elements C1₀ to C1ₙ because the image data transmitted by the data bus DB1 are serial data. During the image data transmission, the pixel switch elements Q2₀ to Q2ₙ of the corresponding pixel are turned on for writing the needed image data into the pixel equivalent capacitances C2₀ to C2ₙ. When the next image data are written into the pixel electrically connected to the scan line SL2, the sample-hold switch elements Q1₀ to Q1ₙ are also turned on for transmitting the image data into the sample-hold energy-storage elements C1₀ to C1ₙ, respectively. Similarly, during the image data transmission, the pixel switch elements Q3₀ to Q3ₙ corresponding to the pixel are turned on.

To be noted, for maintaining the correct image data, the capacitance of the sample-hold energy-storage element must be greater than 10 times of the pixel equivalent capacitance.

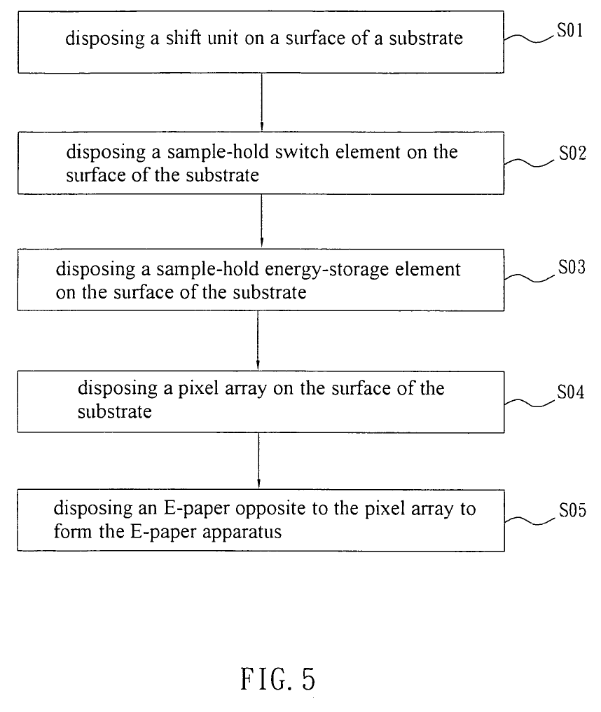

In addition, as shown in FIG. 5, the manufacturing method of the E-paper according to the embodiment of the invention includes the following steps S01 to S05.

As shown in FIG. 5, the step S01 is to dispose a shift unit on a surface of a substrate. The step S02 is to dispose a sample-hold switch element on the surface of the substrate. The step S03 is to dispose a sample-hold energy-storage element on the surface of the substrate. The step S04 is to dispose a pixel array on the surface of the substrate. The step S05 is to dispose an E-paper opposite to the pixel array to form the E-paper apparatus. The shift unit, the sample-hold switch element and the sample-hold energy-storage element can construct a driving circuit. In the embodiment, the driving circuit is a column driving circuit, for example.

The order of the steps of the invention is not limited to that described above. In practice, the order of the steps can be changed according to requirement; otherwise, the steps can be performed at the same time. In addition, the method for performing the above steps can be any one of the following three aspects.

In the first aspect, the shift unit, the sample-hold switch element, the sample-hold energy-storage unit and the pixel array are formed on the substrate by a TFT process, such as an amorphous Si TFT process. In the second aspect, the shift unit is disposed in a chip, and the chip is then disposed on the substrate by a COG (chip on glass) process. The sample-hold switch element, the sample-hold energy-storage unit and the pixel array are formed on the substrate by TFT process. In the third aspect, the driving circuit mentioned above is disposed in a chip, and the chip is then disposed on the substrate. The pixel array is formed on the substrate by amorphous Si TFT process. To be noted, the method for performing the steps of the invention is not limited to the above-mentioned aspects and can be changed according to actual requirements.

In summary, the E-paper apparatus and its driving circuit of the invention utilize the shift unit, the sample-hold switch element and the sample-hold energy-storage element to form the driving circuit for driving the pixel array of the E-paper to display the image. Comparing to the prior art, the driving circuit of the invention is simpler, and the manufacturing process thereof can be integrated with that of the pixel array so as to reduce the manufacturing cost.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A driving circuit of an electronic paper apparatus for driving at least one pixel having a pixel switch element, comprising:
a shift unit outputting a switch control signal; and
a sample-hold unit having a sample-hold switch element electrically connected to the pixel switch element of the pixel and the shift unit, and a sample-hold energy-storage element electrically connected to the pixel switch element of the pixel and the sample-hold switch element, wherein the sample-hold switch element turns on or turns off in accordance with the switch control signal.

2. The driving circuit of claim 1, wherein the sample-hold switch element comprises a thin-film transistor having a gate, a source and a drain.

3. The driving circuit of claim 1, wherein the sample-hold energy-storage element comprises a capacitance located between a data line and any conductive layer.

4. The driving circuit of claim 1, wherein the shift unit is a shift register.

5. The driving circuit of claim 1, wherein the pixel further comprises a pixel equivalent capacitance electrically connected to the pixel switch element for receiving a pixel data through the pixel switch element.

6. The driving circuit of claim 1, wherein at least one of the shift unit, the sample-hold switch element and the sample-hold energy-storage element is disposed in a chip.

7. The driving circuit of claim 1, wherein the pixel switch element of the pixel is formed on a substrate.

8. The driving circuit of claim 7, wherein at least one of the shift unit, the sample-hold switch element and the sample-hold energy-storage element is formed on the substrate.

9. The driving circuit of claim 7, wherein the substrate is a glass substrate.

10. An electronic paper apparatus, comprising:
a substrate having a surface;
a driving circuit, which is disposed on the surface, and has a shift unit and a sample-hold unit, wherein the sample-hold unit has a sample-hold switch element and a sample-hold energy-storage element, and the sample-hold switch element is electrically connected to the shift unit and the sample-hold energy-storage element; and
a pixel array having a plurality of pixels disposed on the surface of the substrate, wherein one of the pixels has a pixel equivalent capacitance and a pixel switch element electrically connected to the sample-hold switch element, the sample-hold energy-storage element and the pixel equivalent capacitance.

11. The electronic paper apparatus of claim 10, wherein the sample-hold switch element comprises a thin-film transistor having a gate, a source and a drain.

12. The electronic paper apparatus of claim 10, wherein the sample-hold energy-storage element comprises a capacitance located between a data line and any conductive layer.

13. The electronic paper apparatus of claim 10, wherein the shift unit is a shift register.

14. The electronic paper apparatus of claim 10, wherein at least one of the shift unit, the sample-hold switch element and the sample-hold energy-storage element is disposed in a chip.

15. The electronic paper apparatus of claim 10, wherein at least one of the shift unit, the sample-hold switch element and the sample-hold energy-storage element is formed on the surface of the substrate.

16. The electronic paper apparatus of claim 10, further comprising an electronic paper disposed opposite to the pixel array.

17. The electronic paper apparatus of claim 16, wherein the electronic paper comprises:
an opposite electrode unit disposed opposite to the pixel array; and
an electrophoretic material unit disposed between the opposite electrode unit and the pixel array.

18. The electronic paper apparatus of claim 10, wherein the substrate is a glass substrate.

19. A manufacturing method of an electronic paper apparatus, comprising:
disposing a shift unit on a surface of a substrate;
disposing a sample-hold switch element on the surface of the substrate;
disposing a sample-hold energy-storage element on the surface of the substrate; and
disposing a pixel array on the surface of the substrate.

20. The manufacturing method of claim 19, wherein the pixel array is formed on the surface of the substrate by way of a thin-film transistor process or an amorphous Si TFT process.

21. The manufacturing method of claim 19, wherein the shift unit is formed on the surface of the substrate by way of a thin-film transistor process or an amorphous Si TFT process.

22. The manufacturing method of claim 19, wherein the sample-hold switch element is formed on the surface of the substrate by way of a thin-film transistor process or an amorphous Si TFT process.

23. The manufacturing method of claim 19, wherein the sample-hold energy-storage element is formed on the surface of the substrate by way of a thin-film transistor process or an amorphous Si TFT process.

24. The manufacturing method of claim 19, wherein the shift unit is formed on the surface of the substrate by way of a COG (chip on glass) process.

25. The manufacturing method of claim 19, further comprising a step of:
disposing an electronic paper opposite to the pixel array.
